(19) United States
(12) Patent Application Publication
(10) Pub. No.: US 2014/0129806 A1
(43) Pub. Date: May 8, 2014

(54) LOAD/STORE PICKER

(71) Applicant: Advanced Micro Devices, Inc., Funnyvale, CA (US)

(72) Inventor: David A. Kaplan, Austin, TX (US)

(21) Appl. No.: 13/672,224

(22) Filed: Nov. 8, 2012

(51) Int. Cl. G06F 9/30

(52) U.S. Cl. 712/220; 712/E09.016

(57) ABSTRACT

A method and apparatus for picking load or store instructions is presented. Some embodiments of the method include determining that the entry in the queue includes an instruction that is ready to be executed by the processor based on at least one instruction-based event and concurrently determining cancel conditions based on global events of the processor. Some embodiments also include selecting the instruction for execution when the cancel conditions are not satisfied.

### BACKGROUND

This application relates generally to processing systems, and, more particularly, to picking load or store operations in processing systems.

Processing systems utilize two basic memory access instructions or operations: a store instruction that writes information that is stored in a register into a memory location and a load instruction that loads information stored at a memory location into a register. High-performance out-of-order execution microprocessors can execute memory access instructions (loads and stores) out of program order. For example, a program code may include a series of memory access instructions including loads (L1, L2, . . . ) and stores (S1, S2, . . . ) that are to be executed in the order: S1, L1, S2, L2, . . . . However, the out-of-order processor may select the instructions in a different order such as L1, L2, S1, S2, . . . . Some instruction set architectures require strong ordering of memory operations (e.g. the x86 instruction set architecture). Generally, memory operations are strongly ordered if they appear to have occurred in the program order specified.

Store and load instructions typically operate on memory locations in one or more caches associated with the processor. Values from store instructions are not committed to the memory system (e.g., the caches) immediately after execution of the store instruction. Instead, the store instructions, including the memory address and store data, are buffered in a store instruction queue. Buffering allows the stores to be written in correct program order even though they may have been executed in a different order. At some later point, the store retires and the buffered data is written to the memory system. Buffering stores may provide better performance by allowing stores to continue to retire without waiting for the cache to be written. For example, processing systems typically have less cache write bandwidth than retire bandwidth and buffering stores may therefore allow retirements to proceed using the larger retire bandwidth while stores may be waiting to use the smaller cache write bandwidth. Load instructions, including the memory address and loaded data, can also be held in a load instruction queue until the load instruction has completed.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

Processing units such as a central processing unit (CPU), a graphics processing unit (GPU), or an accelerated processing unit (APU) execute programs or sequences of assembly instructions. The assembly instructions may be broken down into one or more “micro-ops” that are then executed by the processing unit. Instructions or micro-ops that include a load or store instruction are executed by a load store (LS) unit that includes queues for tracking and executing the instructions or operations. Processing units have a limited number of execution pipes for executing the load or store operations. A load store picker is responsible for selecting instructions for operations from the queues and issuing them to the execution pipes. Configuring the load store picker to satisfy the competing demands for processing resources may lead to very complicated logic that can be very difficult to implement and verify. The disclosed subject matter is directed to addressing the effects of one or more of the problems set forth above.

In some embodiments, a method is provided for picking load or store instructions. Some embodiments of the method include determining that the entry in the queue includes an instruction that is ready to be executed by the processor based on at least one instruction-based event and concurrently determining cancel conditions based on global events of the processor. Some embodiments also include selecting the instruction for execution when the cancel conditions are not satisfied.

In some embodiments, an apparatus is provided for picking load or store instructions. Some embodiments of the apparatus include one or more queues for holding entries. The queue(s) include registers that store information indicating whether an entry is ready for execution. Some embodiments of the apparatus also includes a picker configurable to determine that the entry in the queue includes an instruction that is ready to be executed by the processor based on at least one instruction-based event and concurrently determine cancel conditions based on global events of the processor. Some embodiments also include selecting the instruction for execution when the cancel conditions are not satisfied.

In some embodiments, a computer readable media is provided that includes instructions that when executed can configure a manufacturing process used to manufacture a semiconductor device that includes one or more queues for holding entries. The queue(s) include registers that store information indicating whether an entry is ready for execution. The semiconductor device also includes a picker configurable to determine that the entry in the queue includes an instruction that is ready to be executed by the processor based on at least one instruction-based event and concurrently determine cancel conditions based on global events of the processor. Some embodiments also include selecting the instruction for execution when the cancel conditions are not satisfied.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates an example of a computer system, according to some embodiments;

FIG. 2 conceptually illustrates an example of a semiconductor device that may be formed in or on a semiconductor wafer, according to some embodiments;

FIG. 3 conceptually illustrates an example of logic that can be used to choose queued instructions for execution, according to some embodiments;

FIG. 4 conceptually illustrates an example of a finite state machine, according to some embodiments;

FIG. 5 conceptually illustrates an example of an age matrix as it is formed and modified by the addition and removal of instructions, according to some embodiments; and

FIG. 6 conceptually illustrates an example of a method for selecting queue entries for execution, according to some embodiments.

While the disclosed subject matter may be modified and may take alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter.

Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the disclosed embodiments with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

A load store picker in a processing unit such as a central processing unit (CPU), a graphics processing unit (GPU), or an accelerated processing unit (APU) is responsible for selecting instructions for operations from the queues and dispatching them to execution pipelines. The LS picker balances many competing demands for resources in the processing unit. For example, an instruction or micro-op may need to execute multiple times. A load may be replayed (aka, re-executed) when the load misses the translation lookaside buffer (TLB). The load may also miss the cache, do a fill, pick up data from the fill, etc. The LS picker may further be configured to maintain prioritization or fairness among both micro-ops and other internal request logic such as a tablewalker or a hardware prefetcher. The LS picker must also be able to delay picking some (or all) micro-ops when external events (e.g., a returning fill) interrupt the execution pipe(s). The logic used to implement the LS picker may therefore become very complicated and include numerous timing paths. Configuring and verifying the logic may be correspondingly difficult.

Conventional designs attempt to address these problems in different ways. For example, many processors simplify the problem by requiring that loads and stores execute strictly in program order so that only one op is executed at a time. However, this approach degrades processor performance at least in part because every instruction must wait for every previous instruction to complete before it can be executed. Other processor designs incorporate additional execution pipes that are dedicated to internal request logic (e.g., the tablewalker or the prefetcher). In embodiments of this design, the load or store requests from internal request logic do not have to contend with load or store requests from ops or instructions in the executing program, which may be referred to as “demand” requests. However, incorporating additional execution pipes costs hardware and may not be practical or possible in all cases, particularly when there are significant cost, power, or area constraints on the processor design. Other processor designs implement separate schedulers that can be used to schedule loads or stores under different conditions. For example, some processor designs include as many as four different logic structures that implement different algorithms for selecting a load or store in different circumstances.

The embodiments described herein address some or all of these drawbacks in conventional processors using a simplified queue structure. In some embodiments, load or store requests are placed into a corresponding load instruction queue or store instruction queue. Each entry in a queue includes information indicating whether the corresponding request is ready to be scheduled for execution in a load instruction pipeline or store instruction pipeline. For example, each entry may include a ready bit that can be set or unset by a finite state machine associated with the load instruction queue or the store instruction queue. The scheduler then selects an entry such as the oldest ready entry from each queue. This may be done, for example, if the scheduler maintains age matrices that indicate the relative ages of each entry in the corresponding queues. Concurrently with determining the oldest ready entry, the scheduler may also evaluate one or more cancel conditions for one or more of the queue entries. A “cancel condition” is a condition that indicates that one or more of the entries should not be executed during the current cycle. The cancel conditions are applied to the oldest ready entry for each queue to determine whether the oldest ready entry is selected during the current cycle. In some embodiments, different priorities may be assigned to demand ops and internal requests such as a tablewalk or a prefetch. For example, internal requests may be assigned an “age” that reflects their priority and the scheduler may use the assigned ages when selecting the oldest ready entry from each queue.

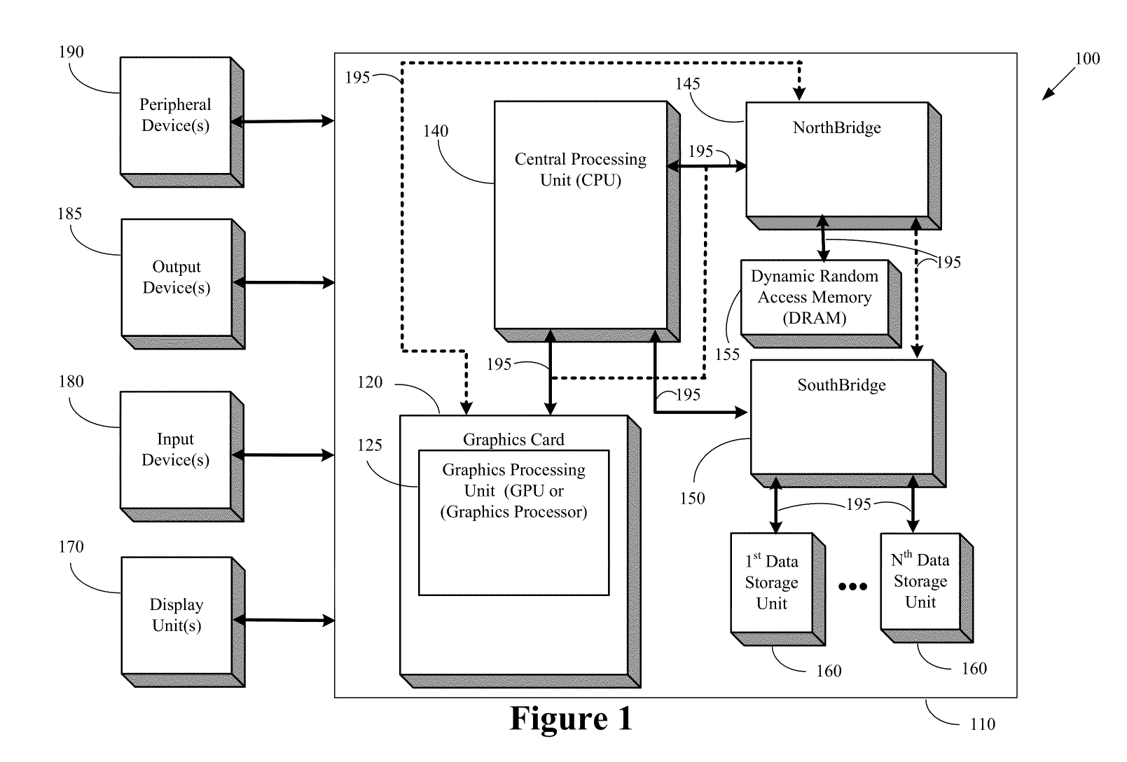

FIG. 1 conceptually illustrates an example of a computer system 100, according to some embodiments. In various embodiments, the computer system 100 may be a personal computer, a laptop computer, a handheld computer, a netbook computer, a mobile device, a tablet computer, a netbook, an ultrabook, a telephone, a smart television, a personal data assistant (PDA), a server, a mainframe, a work terminal, or the like. The computer system includes a main structure 110 which may be a computer motherboard, system-on-a-chip, circuit board or printed circuit board, a television board, a desktop computer enclosure or tower, a laptop computer base, a server enclosure, part of a mobile device, tablet, personal data assistant (PDA), or the like. In some embodiments, the computer system 100 runs an operating system such as Linux®, Unix®, Windows®, Mac OS®, or the like.

In the illustrated embodiment, the main structure 110 includes a graphics card 120. For example, the graphics card 120 may be an ATI Radeon™ graphics card from Advanced Micro Devices (“AMD”). The graphics card 120 may, in different embodiments, be connected on a Peripheral Component Interconnect (PCI) Bus (not shown), PCI-Express Bus (not shown), an Accelerated Graphics Port (AGP) Bus (also not shown), or other electronic or communicative connection. In some embodiments, the graphics card 120 may contain a graphics processing unit (GPU) 125 used in processing graphics data. In various embodiments the graphics card 120 may be referred to as a circuit board or a printed circuit board or a daughter card or the like.

The computer system 100 shown in FIG. 1 also includes a central processing unit (CPU) 140, which is electronically or communicatively coupled to a northbridge 145. The CPU 140 and northbridge 145 may be housed on the motherboard (not shown) or some other structure of the computer system 100. It is contemplated that in some embodiments, the graphics card 120 may be coupled to the CPU 140 via the northbridge 145 or some other electronic or communicative connection. For example, CPU 140, northbridge 145, GPU 125 may be included in a single package or as part of a single die or “chip”. In some embodiments, the northbridge 145 may be coupled to a system RAM (or DRAM) 155 and in some embodiments the system RAM 155 may be coupled directly to the CPU 140. The system RAM 155 may be of any RAM type known in the art; the type of RAM 155 may be a matter of design choice. In some embodiments, the northbridge 145 may be connected to a southbridge 150. In other embodiments, the northbridge 145 and southbridge 150 may be on the same chip in the computer system 100, or the northbridge 145 and southbridge 150 may be on different chips. In various embodiments, the southbridge 150 may be connected to one or more data storage units 160. The data storage units 160 may be hard drives, solid state drives, magnetic tape, or any other writable media used for storing data. In various embodiments, the central processing unit 140, northbridge 145, southbridge 150, graphics processing unit 125, or DRAM 155 may be a computer chip or a silicon-based computer chip, or may be part of a computer chip or a silicon-based computer chip. In one or more embodiments, the various components of the computer system 100 may be operatively, electrically or physically connected or linked with a bus 195 or more than one bus 195.

The computer system 100 may be connected to one or more display units 170, input devices 180, output devices 185, or peripheral devices 190. In various alternative embodiments, these elements may be internal or external to the computer system 100, and may be wired or wirelessly connected. The display units 170 may be internal or external monitors, television screens, handheld device displays, touchscreens, and the like. The input devices 180 may be any one of a keyboard, mouse, track-ball, stylus, mouse pad, mouse button, joystick, scanner or the like. The output devices 185 may be any one of a monitor, printer, plotter, copier, or other output device. The peripheral devices 190 may be any other device that can be coupled to a computer. Example peripheral devices 190 may include a CD/DVD drive capable of reading or writing to physical digital media, a USB device, Zip Drive®, non-volatile memory, external floppy drive, external hard drive, phone or broadband modem, router/gateway, access point or the like.

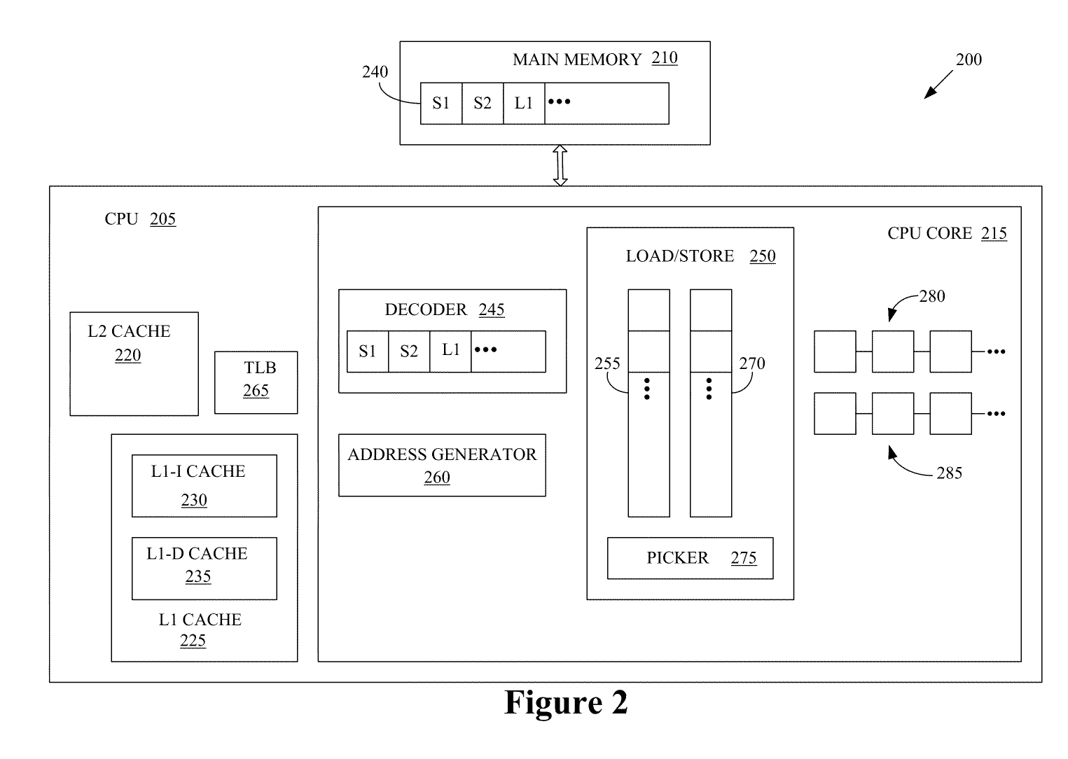

FIG. 2 conceptually illustrates an example of a portion of a semiconductor device 200 that may be formed in or on a semiconductor wafer (or die), according to some embodiments. The semiconductor device 200 may be formed in or on the semiconductor wafer using well known processes such as deposition, growth, photolithography, etching, planarising, polishing, annealing, and the like. In some embodiments, the semiconductor device 200 may be implemented in embodiments of the computer system 100 shown in FIG. 1. As illustrated in FIG. 2, the device 200 includes a central processing unit (CPU) 205 (such as the CPU 140 shown in FIG. 1) that is configured to access instructions or data that are stored in the main memory 210. However, as should be appreciated by those of ordinary skill the art, the CPU 205 is intended to be illustrative and alternative embodiments may include other types of processor such as the graphics processing unit (GPU) 125 depicted in FIG. 1, a digital signal processor (DSP), an accelerated processing unit (APU), a co-processor, an applications processor, and the like. As illustrated in FIG. 2, the CPU 205 includes at least one CPU core 215 that is used to execute the instructions or manipulate the data. Alternatively, the processing system 200 may include multiple CPU cores 215 that work in concert with each other or independently. The CPU 205 also implements a hierarchical (or multilevel) cache system that is used to speed access to the instructions or data by storing selected instructions or data in the caches. However, persons of ordinary skill in the art having benefit of the present disclosure should appreciate that alternative embodiments of the device 200 may implement different configurations of the CPU 205, such as configurations that use external caches. Caches are typically implemented in static random access memory (SRAM), but may also be implemented in other types of memory such as dynamic random access memory (DRAM).

The illustrated cache system includes a level 2 (L2) cache 220 for storing copies of instructions or data that are stored in the main memory 210. In some embodiments, the L2 cache 220 is 16-way associative to the main memory 210 so that each line in the main memory 210 can potentially be copied to and from 16 particular lines (which are conventionally referred to as “ways”) in the L2 cache 220. However, persons of ordinary skill in the art having benefit of the present disclosure should appreciate that alternative embodiments of the main memory 210 or the L2 cache 220 can be implemented using any associativity. Relative to the main memory 210, the L2 cache 220 may be implemented using smaller and faster memory elements. The L2 cache 220 may also be deployed logically or physically closer to the CPU core 215 (relative to the main memory 210) so that information may be exchanged between the CPU core 215 and the L2 cache 220 more rapidly or with less latency.

The illustrated cache system also includes an L1 cache 225 for storing copies of instructions or data that are stored in the main memory 210 or the L2 cache 220. Relative to the L2 cache 220, the L1 cache 225 may be implemented using smaller and faster memory elements so that information stored in the lines of the L1 cache 225 can be retrieved quickly by the CPU 205. The L1 cache 225 may also be deployed logically or physically closer to the CPU core 215 (relative to the main memory 210 and the L2 cache 220) so that information may be exchanged between the CPU core 215 and the L1 cache 225 more rapidly or with less latency (relative to communication with the main memory 210 and the L2 cache 220). Persons of ordinary skill in the art having benefit of the present disclosure should appreciate that the L1 cache 225 and the L2 cache 220 represent an example of a multi-level hierarchical cache memory system. Alternative embodiments may use different multilevel caches including elements such as L0 caches, L1 caches, L2 caches, L3 caches, and the like.

In some embodiments, the L1 cache 225 is separated into level 1 (L1) caches for storing instructions and data, which are referred to as the L1-I cache 230 and the L1-D cache 235. Separating or partitioning the L1 cache 225 into an L1-I cache 230 for storing only instructions and an L1-D cache 235 for storing only data may allow these caches to be deployed closer to the entities that are likely to request instructions or data, respectively. Consequently, this arrangement may reduce contention, wire delays, and generally decrease latency associated with instructions and data. In some embodiments, a replacement policy dictates that the lines in the L1-I cache 230 are replaced with instructions from the L2 cache 220 and the lines in the L1-D cache 235 are replaced with data from the L2 cache 220. However, persons of ordinary skill in the art should appreciate that some embodiments of the L1 cache 225 may not be partitioned into separate instruction-only and data-only caches 230, 235. The caches 220, 225, 230, 235 can be flushed by writing back modified (or “dirty”) cache lines to the main memory 210 and invalidating other lines in the caches 220, 225, 230, 235. Cache flushing may be required for some instructions performed by the CPU 205, such as a RESET or a write-back-invalidate (WBINVD) instruction.

Processing systems utilize at least two basic memory access instructions: a store instruction that writes information that is stored in a register into a memory location and a load instruction that loads information started in a memory location into a register. The CPU core 215 can execute programs that are formed using instructions such as loads and stores. In some embodiments, programs are stored in the main memory 210 and the instructions are kept in program order, which indicates the logical order for execution of the instructions so that the program operates correctly. For example, the main memory 210 may store instructions for a program 240 that includes the stores S1, S2 and the load L1 in program order. Persons of ordinary skill in the art having benefit of the present disclosure should appreciate that the program 240 may also include other instructions that may be performed earlier or later in the program order of the program 240. As used herein, the term “instruction” will be understood to refer to the representation of an action performed by the CPU core 215. Consequently, in various alternative embodiments, an instruction may be an assembly level instruction, one of a plurality of micro-ops that make up an assembly level instruction, or some other operation.

Some embodiments of the CPU core 215 include a decoder 245 that selects and decodes program instructions so that they can be executed by the CPU core 215. The decoder 245 can dispatch, send, or provide the decoded instructions to a load/store unit 250. In some embodiments, the CPU core 215 is an out-of-order processor that can execute instructions in an order that differs from the program order of the instructions in the associated program. The decoder 245 may therefore select or decode instructions from the program 240 and then provide the decoded instructions to the load/store unit 250, which may store the decoded instructions in one or more queues. Program instructions provided to the load/store unit 250 by the decoder 245 may be referred to as “demand requests,” “external requests,” or the like. The load/store unit 250 may select the instructions in the order L1, S1, S2, which differs from the program order of the program 240 because the load L1 is selected before the stores S1, S2.

In some embodiments, the load/store unit 250 implements a queue structure that includes one or more store instruction queues 255 that are used to hold the stores and associated data. In some embodiments, the data location for each store instruction is indicated by a linear address generated by an address generator 260, which may be translated into a physical address so that data can be accessed from the main memory 210 or one of the caches 220, 225, 230, 235. The CPU 205 may therefore include a translation look aside buffer (TLB) 265 that is used to translate linear addresses into physical addresses. When a store instruction (such as S1 or S2) is picked, the store instruction may check the data caches 220, 225, 230, 235 for the data used by the store instruction. The store instruction may be placed in the store instruction queue 255 on dispatch from the decoder 245. In some embodiments, the store instruction queue may be divided into multiple portions/queues so that store instructions may live in one queue until they are picked and receive a TLB translation and then the store instructions can be moved to another queue. In these embodiments, the second queue is the only one that holds data for the store instructions. In some embodiments, the store instruction queue 255 is implemented as one unified queue for stores so that each store can receive data at any point (before or after the pick). For example, the store instruction queue 255 may include a first queue that holds store instructions until they get a TLB translation and a second queue that holds stores from dispatch onwards. In this example, the store instruction actually lives in two queues until it receives a TLB translation.

One or more load instruction queues 270 are also implemented in some embodiments of the CPU 205 shown in FIG. 2. Load data may also be indicated by linear addresses and so the linear addresses for load data may be translated into a physical address by the TLB 265. As illustrated in FIG. 2, when a load instruction (such as L1) is picked, the load checks the TLB 265 or the data caches 220, 225, 230, 235 for the data used by the load. The load instruction can also use the physical address to check the store instruction queue 255 for address matches. Alternatively, linear addresses can be used to check the store instruction queue 255 for address matches. If an address (linear or physical depending on the embodiment) in the store instruction queue 255 matches the address of the data used by the load instruction, then store-to-load forwarding can be used to forward the data from the store instruction queue 255 to the load instruction in the load instruction queue 270.

The load/store unit 250 may also handle load or store requests generated internally by other elements in the CPU 205. These requests may be referred to as “internal instructions” or “internal requests” and the element that issues the request may be referred to as an “internal requester.” The load or store requests generated internally may also be provided to the load store unit 250, which may place the request in entries in the load instruction queue 255 or the store instruction queue 270. Embodiments of the load store unit 250 may therefore process internal and external demand requests in a unified manner, which may reduce power consumption, reduce the complexity of the logic used to implement the load store unit 250, or reduce or eliminate arbitration logic needed to coordinate the selection of instructions from different sets of queues.

In some embodiments, internal requests may be generated by table walking. The CPU 205 may perform tablewalks that include instructions that may generate load or store requests. A “tablewalk” may include reading one or more memory locations in an attempt to determine a physical address for an operation. For example, when a load or store instruction “misses” in the TLB 265, processor hardware typically performs a tablewalk in order to determine the correct linear-to-physical address translation. In x86 architectures, for example, this may involve reading potentially multiple memory locations, and potentially updating bits (e.g., “access” or “dirty” bits) in the page tables. In alternative embodiments, a tablewalk may be performed on a cache or a non-cache memory structure. In some embodiments, the CPU 205 may perform tablewalker using a table walking engine (not shown in FIG. 2).

Load or store requests may also be generated by prefetchers that prefetch lines into one or more of the caches 220, 225, 230, 235. In various embodiments, the CPU 205 may implement one or more prefetchers (not shown in FIG. 2) that can be used to populate the lines in the caches 220, 225, 230, 235 before the information in these lines has been requested from the cache 220, 225, 230, 235. The prefetcher can monitor memory requests associated with applications running in the CPU 205 and use the monitored requests to determine or predict that the CPU 205 is likely to access a particular sequence of memory addresses in the main memory. For example, the prefetcher may detect sequential memory accesses by the CPU 205 by monitoring a miss address buffer that stores addresses of previous cache misses. The prefetcher may then fetch the information from locations in the main memory 210 in a sequence (and direction) determined by the sequential memory accesses in the miss address buffer and stores this information in the cache so that the information is available before it is requested by the CPU 205. Prefetchers can keep track of multiple streams and independently prefetch data for the different streams.

The load/store unit 250 includes a picker 275 that is used to pick instructions from the queues 255, 270 for execution by the CPU core 215. As illustrated in FIG. 2, the picker 275 can select a subset of the entries in the queues 255, 270 based on information in registers (not shown in FIG. 2) associated with the entries. The register information indicates whether each entry is ready for execution and the picker 275 adds the entries that are ready to the subset for each queue 255, 270. The picker 275 may select one of the ready entries from the subsets based on a selection policy. In some embodiments, the selection policy may be to select the oldest ready to three from the subset. For example, the picker 275 may implement or access one or more age matrices that indicate relative ages of the entries in the queues 255, 270. In some embodiments, the picker 275 may implement different selection policies for the different queues 255, 270. The selected ready entries are considered potential candidates for execution. The picker 275 may also determine cancel conditions that indicate that one or more of the entries should not be executed during the current cycle. The picker 275 uses the cancel conditions to determine whether to pick or bypass the selected ready entries.

As illustrated in FIG. 2, the CPU core 215 includes one or more instruction execution pipelines 280, 285. For example, the execution pipeline 280 may be allocated to process load instructions and the execution pipeline 285 may be allocated to process store instructions. However, alternative embodiments of the CPU core 215 may use more or fewer execution pipelines and may associate the execution pipelines with different types of instructions. Load or store instructions selected by the picker 275 that satisfy the cancel conditions may be issued to the execution pipelines 280, 285 for execution.

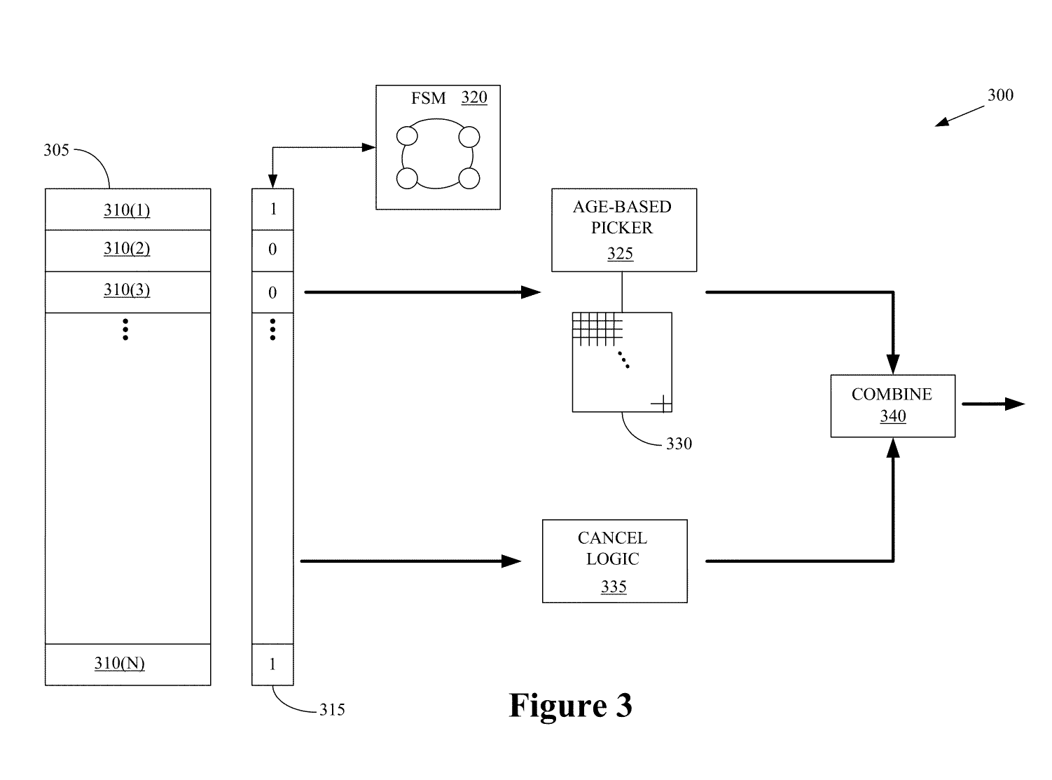

FIG. 3 conceptually illustrates an example of logic 300 that can be used to choose queued instructions for execution, according to some embodiments. Embodiments of the logic 300 may be used to implement the picker 275 shown in FIG. 2. As illustrated in FIG. 3, logic 300 includes one or more queues 305 that include a plurality of entries 310 for instructions that are to be executed. For example, the queues 305 may be implemented in a load store unit and the entries 310 may be used to hold load instructions or store instructions that are awaiting execution by an associated execution pipeline. The entries 310 are associated with corresponding registers in a register set 315. Information in the registers indicates whether or not the entries 310 are ready for execution. For example, the registers may store bits that indicate that an entry is ready for execution if the value of the bit is set to “1” or the entry is not ready for execution if the value of the bit is set to “0.” Entries 310(1), 310(N) are indicated as ready in FIG. 3. Instructions that have their ready bit set are considered by the scheduler or picker and instructions that do not have the ready bit set are ignored for the current cycle. As illustrated in FIG. 3, values of the bits may be determined by a finite state machine (FSM) 320 that can set or unset the values of the bits for each cycle.

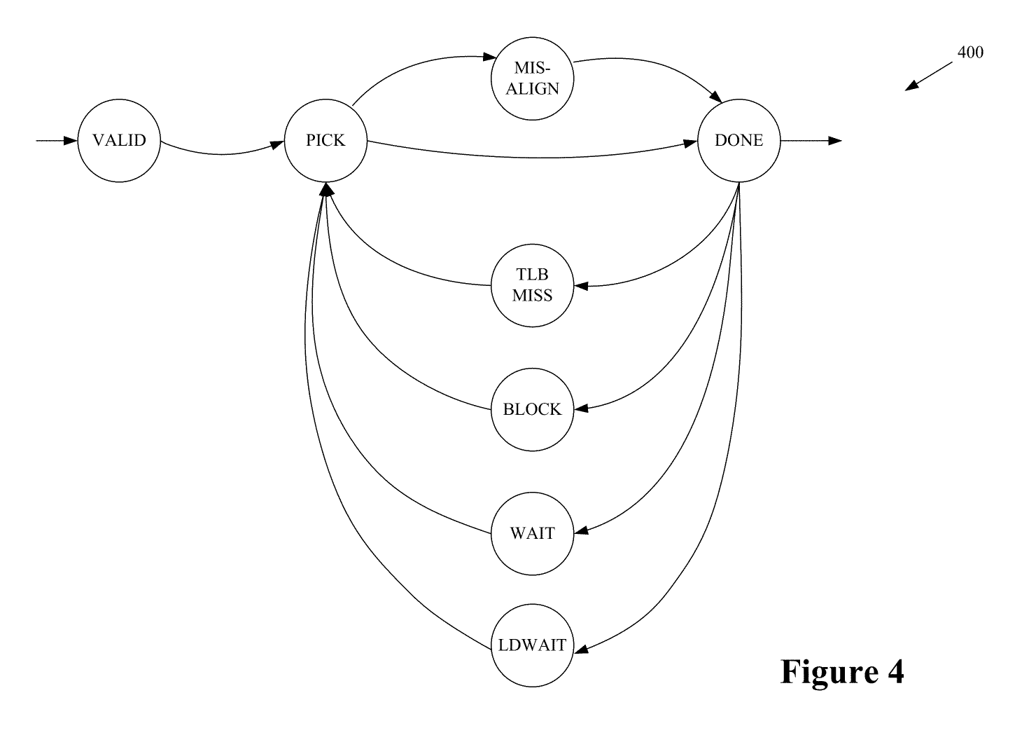

FIG. 4 conceptually illustrates an example of a finite state machine 400 such as the finite state machine 320 shown in FIG. 3, according to some embodiments. The finite state machine 400 determines the state of an instruction (load or store) includes the states VALID, PICK, DONE, MISALIGN, TLB MISS, BLOCK, WAIT, and LDWAIT as illustrated in FIG. 4. Each state may also be associated with one or more conditions. The instruction in an entry of the queue may be marked ready in that state if the conditions associated with the states are satisfied. For example, when the finite state machine 400 for an entry in a queue is in the state A, condition X has to be true, if in state B, condition Y, etc. In some embodiments, the condition may be temporary so that an instruction can be marked ready in one cycle, and then not ready in the next cycle. The value of the ready bit reflects the ready status of its associated instruction. In some embodiments, the value of the ready bit may not include information about other instructions or external conditions that may affect scheduling.

The states shown in FIG. 4 and the corresponding conditions for setting the ready bit may be defined as:
VALID—Indicates that the instruction has been dispatched to the load/store unit and is waiting to be initially picked for scheduling. Instructions may therefore enter the VALID state in response to being dispatched. The instruction may be marked ready by setting the corresponding ready bits when the instruction enters the VALID state. Some embodiments may set the ready bits for instructions in the VALID state depending on additional implementation-specific conditions.
PICK—Indicates the instruction has been selected for scheduling and is flowing through the execution pipe. Instructions may therefore transition from the VALID state to the PICK state in response to being scheduled. Instructions in the TLBMISS/BLOCK/WAIT/LDWAIT states may also transition to PICK in response to being scheduled.
MISALIGN—Indicates that the instruction is misaligned because it is accessing information that straddles a cache line boundary. Aligned operations only look up in the TLB/cache once (in the PICK state), but misaligned instructions look up each half the requested cache information separately, doing the first half in the PICK state and the second half in MISALIGN state. The MISALIGN state is an execution state, like the PICK state and the DONE state.
DONE—Indicates the instruction has finished executing through the pipe and the hardware is evaluating whether the pick was successful, e.g., whether the instruction is really done or if the instruction may need to be replayed. The instruction may therefore transition from the PICK state to the DONE state in response to finishing execution in the pipe. If the instruction successfully completed, then the instruction may be removed from the queue. Otherwise, the instruction may transition to other states, depending on the reason the instruction did not successfully complete. In some embodiments, instructions in the MISALIGN state may go to DONE in response to finishing execution.
TLBMISS—Indicates the instruction missed the TLB and did not receive a physical memory address. Instructions in the TLBMISS state may be marked ready by setting the corresponding ready bit if the instruction subsequently receives an L2TLB hit or if the load store unit is ready for the instruction to start a tablewalk in response to the TLB miss.
BLOCK—Indicates the instruction matched the address of an older store. Instructions in the BLOCK state may be marked ready by setting the corresponding ready bit if the older store commits and writes the data cache. Instructions in the BLOCK state may also be marked ready by setting the corresponding ready bit under other implementation-specific circumstances that may un-block the instruction.
WAITING—Indicates the instruction was unable to complete for some other reason and has to wait to be replayed. Instructions in the WAITING state may be marked ready by setting the corresponding ready bit depending on what they are waiting for. For example, an instruction in the WAITING state may be marked ready when the instruction is a non-cacheable instruction that has to wait to become non-speculative. For another example, if the MABs were full, the WAITING instruction may have to wait for the MABs to become un-full.
The LDWAIT state indicates that a load instruction is waiting on a fill to return. Loads that are non-cacheable or miss in the data cache go to the LDWAIT state when they are waiting for data. Instructions in the LDWAIT state may be marked ready by setting the corresponding ready bit in response to the fill returning.
   Some embodiments of the state machine 400 implements the states in a priority that increases from top-to-bottom in FIG. 4. For example, a load that was blocked and is waiting on a fill goes to the (higher priority) BLOCKED state instead of the (lower priority) LDWAIT state. Store instructions may not go to the BLOCKED or LDWAIT states in some embodiments. Both load instructions and store instructions can go to the MISALIGN state in some embodiments. Persons of ordinary skill in the art having benefit of the present disclosure should appreciate that the states described in FIG. 4 are exemplary and alternative embodiments of the finite state machine 400 may include more, fewer, or different states, e.g., other states may be added, states may be combined, or other ready states may be implemented. In some embodiments, different finite state machines 400 may be associated with the load instruction queue, the store instruction queue, or other queues.

Referring back to FIG. 3, an age-based picker 325 may then choose entries from among the subset of entries that are ready for execution. As illustrated in FIG. 3, the subset includes the entries 310(1), 310(N) because these entries have been marked as ready for execution in the register set 315. The age-based picker 325 may select one of the entries from the subset based on the relative ages of the entries. In some embodiments, the age-based picker 325 may select the oldest ready entry for possible execution. In systems that include multiple execution pipelines, multiple instructions may be picked by the age-based picker 325. For example, if the processing system includes a load instruction pipeline and a store instruction pipeline, the age-based picker 325 may select the oldest ready entry from the load instruction queue and the oldest ready entry from the store instruction queue for execution in the corresponding pipelines.

In some embodiments, the age-based picker 325 determines the relative ages using an age matrix 330 that includes information indicating the relative ages of the instructions in the entries 310 in the queue 305, e.g., instructions that are earlier in program order are older and instructions that are later in program order are younger. As illustrated in FIG. 3, each instruction is associated with a row (X) that indicates that the instruction is in entry (X), e.g. entry 310(1), and a column (Y) that indicates that the instruction is in entry (Y), e.g. entry 310(3). In some embodiments, new instructions are added to the matrix 330 when they become ready or eligible for execution and so they are assigned an entry 310 in the picker. The new instructions may be added to any entry 310 corresponding to any row/column of the matrix 330. The matrix indices therefore do not generally indicate any particular ordering of the instructions and any instruction can use any matrix index that is not already being used by different instruction. The matrix 330 shown in FIG. 3 may be a 16×16 matrix that can support a 16 entry scheduler/buffer. The matrix 330 may therefore be implemented using 16̂2 flops (256 flops). Alternatively, an n×n symmetric age matrix could be implemented in n²/2−n flops since each entry is by definition the same age as itself and so the diagonal elements do not need to be stored, as discussed herein. However, persons of ordinary skill in the art having benefit of the present disclosure should appreciate that the size of the matrix 330 is intended to be an example and the matrix 330 may include more or fewer entries.

Each bit position (X, Y) in the matrix 330 may indicate the age (or program order) relationship of instruction X to instruction Y. For example, a bit value of ‘1’ in the entry (X, Y) may indicate instruction X is younger and later in the program order than instruction Y. A bit value of ‘0’ in the entry (X, Y) may indicate that instruction X is older and earlier in the program order than instruction Y.

Entries in the matrix 330 may have a number of properties that can facilitate efficient use of the matrix 330 for selecting eligible instructions for execution. For example, for any (X, Y) position in the matrix there is also a (Y, X) position that may be used to compare the relative ages (or positions in program order) for the same pair of instructions X and Y in the reverse order. In the general case of X !=Y, either X is older than Y or Y is older than X. Consequently, only one of the entries (X, Y) or (Y, X) in the matrix 330 is set to a value indicating a younger entry, e.g., a bit value of 1. This property may be referred to as “1-hot.” For another example, a particular instruction has no age relationship with itself and so when X=Y (i.e., along the diagonal of the matrix 330) the diagonal entries of the matrix 330 can be set to an arbitrary value, e.g., these entries can be set to ‘0’ or not set. For yet another example, the row corresponding to the oldest ready instruction/operation is a vector of 0 values because the oldest valid instruction is older (e.g., earlier in the program order) than any of the other valid instruction/operations associated with the matrix 330. Similarly, the second oldest valid operation/instruction has one bit in its row set to a value of 1 since this instruction is older than all of the other valid instruction/operations except for the oldest valid instruction. This pattern continues with additional valid instructions so that the third oldest valid instruction/operation has 2 bits in its row set, the fourth oldest valid instruction/operation has three bits set in its row, and so on until (in the case of a full matrix 330 that has 16 valid entries) the youngest instruction/operation has 15 of its 16 bits set. In this example, the 16^{th} bit is not set because this is the bit that is on the diagonal of the matrix 330 and is therefore not set.

Persons of ordinary skill in the art having benefit of the present disclosure should appreciate that some embodiments may implement pickers that use different selection policies to choose from among the subset of entries. Example selection policies may include selecting the youngest ready entry, randomly selecting one of the ready entries, selecting a ready entry that has the largest number of dependencies, or using a priority predictor to estimate priorities for picking each of the ready entries and then picking the entry with the highest estimated priority. The alternative embodiments of the picker may use information about the instructions such as the instruction age, instruction dependencies, or instruction priority to select the entries based on the selection policy. In these embodiments, the ready bits “flow” into the picking algorithm, which may then use the instruction information to choose from among the ready entries based on the selection policy.

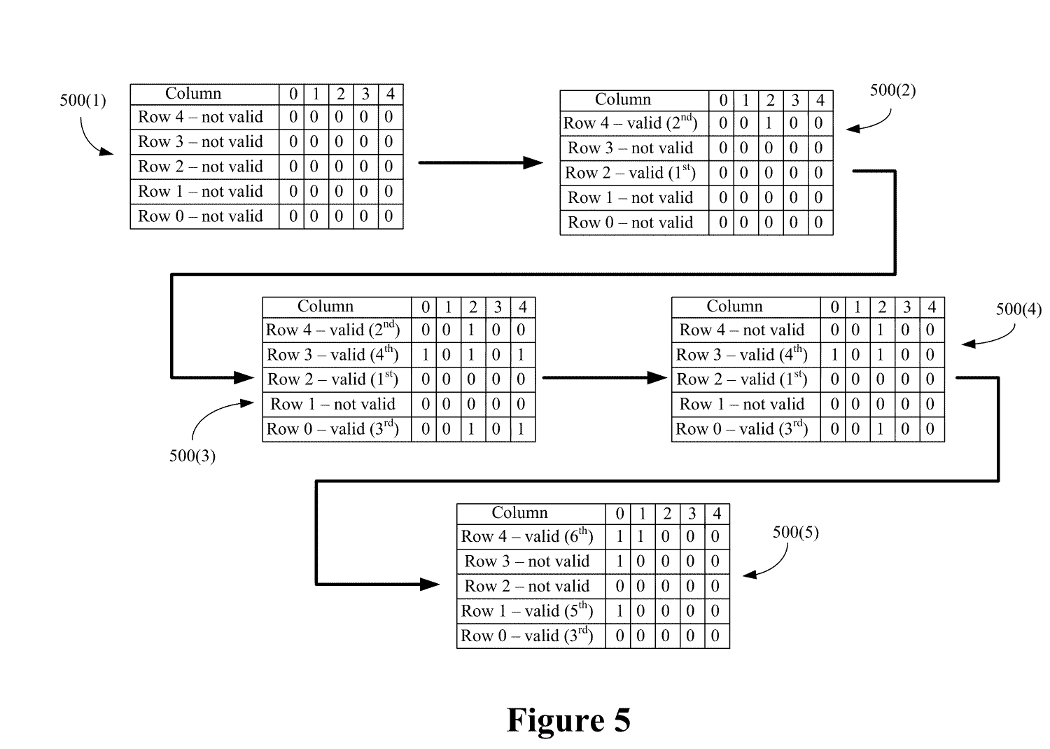

FIG. 5 conceptually illustrates an example of an age matrix 500 as it is formed and modified by the addition and removal of instructions, according to some embodiments. As illustrated in FIG. 5, the matrix 500 is a 5×5 matrix that can be used to indicate the age relationships between up to five instructions that are eligible for execution. However, persons of ordinary skill in the art having benefit of the present disclosure should appreciate that the illustrated size of the matrix 500 is an example and alternative embodiments of the matrix 500 may include more or fewer entries.

In some embodiments, the matrix 500 is updated by row when entries are allocated. For example, each entry corresponds to an instruction that has a known age and so each column value in the entry's row can be determined and updated when an entry is allocated. Up to 2 entries (each corresponding to an instruction that is eligible for execution) could be added per cycle. In some embodiments, instructions/operations are allocated into the scheduler in program order and so instructions/operations that become valid in the current cycle are older than instruction/operations that have already been associated with entries in the matrix 500. When two instructions/operations arrive in the same cycle, the first of instruction is older than the second instruction and so the second instruction accounts for the presence of the older first instruction when setting the values of the bits in its assigned/allocated row.

In some embodiments, the columns of the matrix 500 are cleared when entries are picked and issued. For example, if the system uses two instruction pipelines, up to 2 entries can be picked for execution per cycle, e.g., one entry can be placed on the first pipeline and another entry can be placed on the second pipeline. Clearing columns associated with the issued instructions clears the dependencies for any newer instructions (relative to the issued instructions) and allows the entries that have been previously allocated to the issued instructions to be de-allocated so that a later incoming instruction can re-use that row/column without creating an alias.

During the first cycle 500(1), the matrix 500 is cleared by setting all of the bits to 0 and providing an indication that none of the rows are valid. Two operations arrive during the second cycle 500(2) and these operations are allocated rows 2 and 4. The first operation (the youngest operation) is allocated to row 2 and the second operation (the older of the two) is allocated to row 4. The values of the bits in row 2 are therefore set to 0 and the values of the bits in row 4 are set to zero, except for the value of the position 2, which is set to 1 to indicate that the second operation is older than the first operation. The rows 2 and 4 include valid information. During the third cycle 500(3), third and fourth instructions arrive and are assigned to row 0 and row 3, respectively. The third instruction therefore inserts a valid vector of (00101) into row 0 and the fourth instruction insert a valid vector of (10101) into row 3. The vectors may be “inserted” by setting corresponding bits indicated by the appropriate row/column combinations or the entire vector may be calculated and inserted, e.g., into a register.

The second oldest instruction schedules and is issued for execution in the pipeline during the fourth cycle 500(4). Column 4 may therefore be cleared, e.g., a vector of bit values of (00000) can be written to the entries of column 4 Once column 4 has been cleared, the updated/modified row 0 has only 1 age dependency set with a bit value of 1, which means the instruction allocated to row 0 is now the 2^{nd} oldest op. There is still only 1 valid row with all bits cleared (row 2), 1 valid row with only 1 bit set (row 0), and 1 valid row with only 2 bits set (row 3). Row 4 still has one bit in its row set, but since row 4 is not valid the presence of this bit value does not affect the operation of the matrix 500 or the associated scheduler.

During the fifth cycle 500(5), fifth and six instructions arrive concurrently with the first and fourth instructions issuing. The fifth arriving instruction is inserted in row 1 and the second instruction is inserted in row 4. Entry 2 (which is allocated to the current oldest instruction) and entry 3 both schedule and they perform column clears. In the illustrated embodiment, the column clears take priority over the new row insertions. Therefore the fifth instruction may insert a valid vector of (10110) into row 1 but column clears on columns 2 and 3 take priority for those bits, leading to an effective update of row 1 to bit values of (10000). At this point, the new oldest op is the third instruction sent, which is in entry 0 and has all bits set to 0. The fifth instruction is the second oldest and so row 1 has 1 valid bit set. The sixth instruction is the third oldest and so row 4 has 2 valid bits set. In the illustrated embodiment, row 3 has a bit of debris left over because the entry (3, 0) is still set. This does not affect operation of the matrix 500 or the scheduler because the entry is invalid and any later reuse of this row by a new instruction can set (or clear) the bits correctly.

Referring back to FIG. 3, the logic 300 also includes cancel logic 335 that can be used to determine one or more cancel conditions that may be applied to the one or more selected entries 310. In some embodiments, the cancel logic 335 operates concurrently with the age-based picker 325 to determine the cancel conditions. Operating the cancel logic 335 concurrently with the age-based picker 325 may simplify timing requirements as it does not require the global events (e.g., the cancel conditions) to be wired to every queue entry and furthermore the logic 300 may account for the global events very late in the cycle, e.g. by applying the cancel conditions. Example cancel conditions may include, but are not limited to, internal or external conditions that would restrict the instructions that may be picked during the current cycle. For example, a returning cache fill may occupy the cache tags or data bus and prevent execution of certain types of instructions for a few cycles. For another example, a misalign instruction may require two or more cycles so any instruction that is picked for execution during the cycle following the misalign instruction must be canceled for the current cycle. In some embodiments, the cancel logic 335 may determine multiple different cancel conditions for different types of instructions. For example, loads may be cancelled if some conditions are true, locked loads may be cancelled under different conditions, and stores may be canceled under another set of conditions. The canceled instructions may therefore be bypassed and not executed, even though the age-based picker 325 provisionally selected these instructions for execution.

In some embodiments, the logic 300 includes a combine unit 340 that combines information from the age-based picker 325 and the cancel logic 335 to produce a vector that indicates zero, one, or more ready instructions that satisfy the cancel conditions. For example, if the age-based picker 325 selected a load instruction for execution by one pipeline and a store instruction for execution by another pipeline, and neither of these instructions are canceled by satisfying a cancel condition, the logic 300 may produce a vector that indicates the load instruction and the store instruction are to be picked for execution during the current cycle. For another example, if the age-based picker 325 selected a load instruction for execution by one pipeline and a store instruction for execution by another pipeline, but only the store instruction is canceled by satisfying the cancel conditions, the logic 300 may produce a vector that indicates the load instruction is to be picked for execution during the current cycle. The store instruction is bypassed during the current cycle. For yet another example, if both the load instruction and the store instruction are canceled by satisfying the cancel conditions, both instructions are bypassed during the current cycle.

Embodiments of the logic 300 use the finite state machine 315, the age-based picker 325, and the cancel logic 335 to implement a separation (in both timing and complexity) between individual instruction-based events and global events. Individual instruction-based events may include a fill returning for that instruction, an address being generated for the instruction, an instruction becoming the oldest in the machine, and the like. Example global events may include, but are not limited to, picking a misaligned instruction during the previous cycle, an incoming probe, a cache fill, and the like. Individual events may be taken into account in the ready bit and global events may be taken into account in the cancellation terms. This separation may simplify timing requirements as it does not require the global events to be wired to every queue entry and furthermore the logic 300 may account for the global events very late in the cycle, e.g. by applying the cancel conditions.

In some embodiments, alternative definitions of the “age” of an instruction or entry may be used to establish priorities for different types of instructions. For example, instructions or request generated by internal requesters may be prioritized by assigning appropriate ages to the instructions and modifying the age matrix 330 to reflect these ages. In some embodiments, a priority-based technique may be used to establish ages for instructions generated by a hardware tablewalker, a hardware based prefetcher, or other internal requesters. In some implementations, the internal requesters may share an execution pipe with demand instructions, e.g., in devices that attempt to reduce power consumption. Priority-based ages may support sharing of the execution pipe(s) between demand instructions and internal instructions in a fair and high performance way.

In some embodiments the queue 305 may include queue entries defined for tablewalker instructions that may be treated similarly to demand instructions, which may reduce the complexity of the logic 300 and allow tablewalker instructions to share existing logic with demand or external instructions. Tablewalker instructions may be assigned an age that indicates that these instructions are the “oldest” instruction so that tablewalker instructions may be given the highest priority. Alternatively, tablewalker instructions may be assigned an age corresponding to the instruction that initiated the tablewalk. Another option that may be particularly suitable for instruction-fetch-based tablewalks may be to assign the tablewalk a young age and let the age of the tablewalker instruction grow older over time. For example, the tablewalker instruction may be assigned an age based on when the instruction is issued (like a new demand instruction) and the age of the tablewalker instruction relative to other instructions may be increased in subsequent cycles as other instructions complete to increase the priority for selecting the tablewalker instruction.

Requests issued by a hardware prefetcher may be treated as the lowest priority requestor at all times. When the age-based scheduler does not pick any instructions because none are ready to be executed, the hardware prefetcher may be given access to the execution pipe. An alternate scheme would be to assign the prefetcher a special queue entry and assign these special entries an age according to a prefetcher policy. For example, prefetcher entries may be assigned the oldest age, the youngest age, or they may be allowed to age over time so that they become relatively older than other entries, or other alternatives.

The various alternative embodiments described herein may be relatively easy to implement with embodiments of the picker scheme described herein. Centralizing the pick logic in an age-based engine may give the designer the option to manipulate or control the age assigned to instructions to influence the performance of the overall design. In some embodiments, the age-based policies could be changed dynamically. For example, policies that indicate whether to assign a hardware tablewalk op as the highest priority, or a youngest-but-age-over-time could be controlled or modified via a software visible configuration bit.

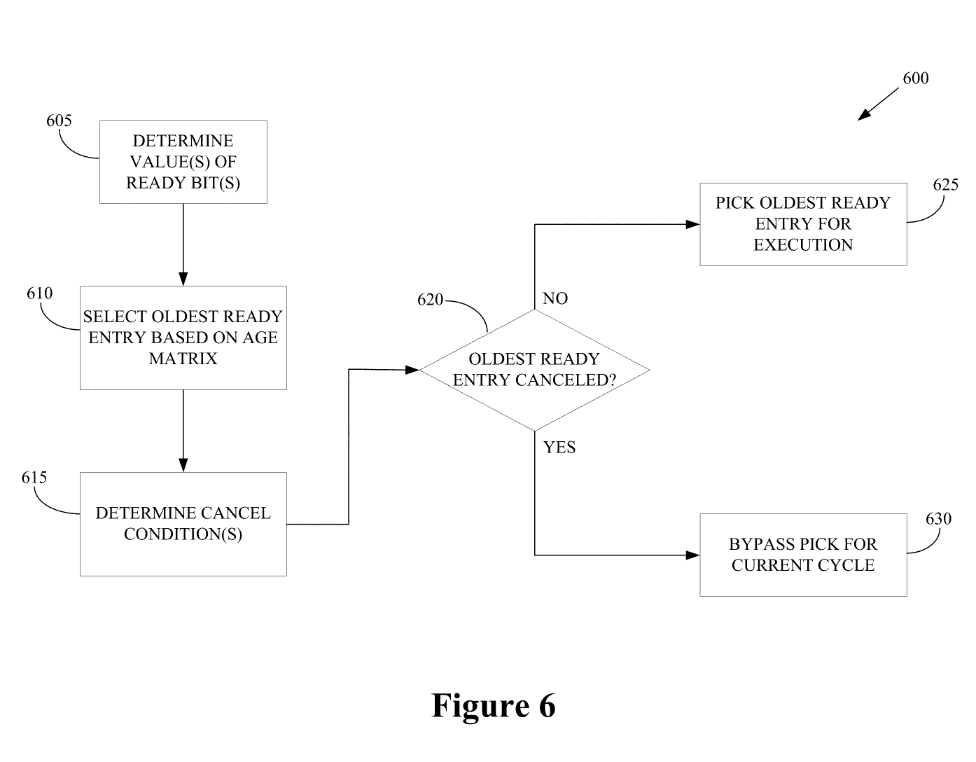

FIG. 6 conceptually illustrates an example embodiment of a method 600 for selecting queue entries for execution, according to some embodiments. In the illustrated embodiment, a queue, such as a load instruction queue or a store instruction queue, includes entries for instructions that may be executed. The instruction entries are associated with ready bits that indicate whether the corresponding instruction is ready to be executed. Values of the ready bits may be determined (at 605) using a finite state machine, as discussed herein. In the illustrated embodiment, the oldest ready entry is then selected (at 610) using an age matrix that indicate the relative ages of the entries in the queue. For example, a subset of the entries that are ready for execution may be identified using the values of the ready bits and then the oldest entry in the subset may be selected (at 610). Cancel conditions that may cause some or all of the selected entries to be canceled may then be determined (at 615). Determination (at 615) of the cancel conditions may proceed concurrently with determining (at 605) the values of the ready bits and selecting (at 610) the oldest ready entry.

The method 600 then determines (at 620) whether the oldest ready entry should be canceled based upon the cancel conditions. If none of the cancel conditions apply to the oldest ready entry (or entries), the oldest ready entry (or entries) may be picked (at 625) for execution and forwarded to the appropriate execution pipeline. However, if one or more cancel conditions indicate that the oldest ready entry (or entries) should be canceled, the oldest ready entry (or entries) may be bypassed (at 630) during the current cycle. Bypassed entries are not forwarded to the execution pipeline for execution.

Embodiments of the techniques described herein may have a number of advantages over conventional practice. Benefits of embodiments of the designs described herein may be found in performance, timing, power, or complexity. Performance may be improved by using a single unified scheduler that can operate very quickly (potentially picking instructions every cycle) using a good performing algorithm (like oldest-ready). For example, embodiments of the instruction picking algorithms described herein may achieve significantly better timing and performance than conventional techniques. In some cases, embodiments of the system described herein may be able to issue almost one instruction per cycle (IPC) or even more than one IPC when multiple execution pipes are implemented. The IPC performance of some embodiments of the system described herein may therefore be significantly increased compared to conventional systems. Timing may be improved using the combination of ready bits and cancel conditions to control where in the design timing sensitive signals flow. Power consumption may be reduced by the unified nature of the picker or through allowing the execution pipe to be easily and effectively shared between demand instructions and other requestors. The complexity of this approach (especially compared to previous designs) is much lower at least in part because of the unified scheduler. For example, the amount of arbitration logic needed to arbitrate between instructions in different queues may be reduced or even eliminated in some cases.

Embodiments of processor systems that implement load store pickers as described herein (such as the processor system 100) can be fabricated in semiconductor fabrication facilities according to various processor designs. In some embodiments, a processor design can be represented as code stored on a computer readable media. Exemplary codes that may be used to define or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on transitory or non-transitory computer readable media and used to configure and control a manufacturing/fabrication process that is performed in a semiconductor fabrication facility. The semiconductor fabrication facility may include processing tools for performing deposition, photolithography, etching, polishing/planarising, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of non-transitory program storage medium or implemented over some type of transmission medium. For example, instructions used to execute or implement some embodiments of the techniques described with reference to FIGS. 3-6 may be encoded on a non-transitory program storage medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
determining that an entry in a queue of a processor includes an instruction that is ready to be executed by the processor based on at least one instruction-based event;
determining cancel conditions based on global events of the processor concurrently with determining that the instruction is ready; and
selecting the instruction for execution when the cancel conditions are not satisfied.

2. The method of claim 1, wherein selecting the instruction for execution comprises selecting an oldest ready entry, selecting a youngest ready entry, randomly selecting one of the ready entries, selecting a ready entry that has the largest number of dependencies, or selecting a ready entry with the highest estimated priority.

3. The method of claim 1, wherein determining that the entry includes the instruction that is ready to be executed comprises selecting the entry using an age matrix that indicates relative ages of a plurality of entries in the queue.

4. The method of claim 3, comprising updating values in the age matrix in response to adding an entry to the queue or removing an entry from the queue.

5. The method of claim 3, comprising determining a priority-based age for the entry, wherein the priority-based age differs from an age indicated by a program order, and determining values in the age matrix using the priority-based age.

6. The method of claim 5, wherein determining the priority-based age comprises determining priority-based ages for entries generated by internal request logic.

7. The method of claim 1, wherein each entry in the queue is associated with a register, and wherein a value of a bit in the register indicates whether the entry is ready for execution.

8. The method of claim 7, further comprising setting the value of the bit using a finite state machine associated with the queue.

9. The method of claim 8, wherein setting the value of the bit for the entry comprises determining a current state associated with the entry and setting the bit in response to determining that at least one condition associated with the state is satisfied.

10. The method of claim 1, wherein the queue comprises a load instruction queue and a store instruction queue, the method further comprising placing a load instruction or a store instruction in an entry of a corresponding load instruction queue or store instruction queue.

11. The method of claim 10, wherein determining that the entry includes the instruction that is ready to be executed comprises selecting a first subset of entries from the load instruction queue and a second subset of entries from the store instruction queue.

12. The method of claim 11, wherein determining that the entry includes the instruction that is ready to be executed comprises selecting a first ready entry from the first subset and a second ready entry from the second subset based on the selection policy, picking or bypassing the first ready entry or the second ready entry based upon said at least one cancel condition, and providing the instructions from first ready entry or the second ready entry to at least one execution pipeline in response to picking the first ready entry or the second ready entry.

13. The method of claim 1, further comprising bypassing the instruction in response to said at least one cancel condition being satisfied.

14. The method of claim 1, further comprising providing the instruction to an execution pipeline in response to selecting the instruction.

15. An apparatus, comprising:
at least one queue for holding entries, wherein the queue comprises registers that store information indicating whether an entry includes an instruction that is ready for execution; and
a picker configurable to:
determine that the entry in the queue includes an instruction that is ready to be executed by the processor based on at least one instruction-based event;
determine cancel conditions based on global events of the processor concurrently with determining that the instruction is ready; and
select the instruction for execution when the cancel conditions are not satisfied.

16. The apparatus of claim 15, wherein the picker is configurable to select an oldest ready entry, select a youngest ready entry, randomly select one of the ready entries, select a ready entry that has the largest number of dependencies, or select a ready entry with the highest estimated priority.

17. The apparatus of claim 16, comprising an age matrix that indicates relative ages of a plurality of entries in the queue, and wherein the picker is configurable to update values in the age matrix in response to adding entries to the queue or removing entries from the queue.

18. The apparatus of claim 16, wherein the picker is configurable to determine a priority-based age for the entry, wherein the priority-based age differs from an age indicated by a program order, and wherein the picker is configurable to determine values in the age matrix using the priority-based age.

19. The apparatus of claim 15, comprising at least one finite state machine configurable to set a value of a bit in the register to indicate that the entry includes the instruction that is ready for execution based on a current state associated with the entry and at least one condition associated with the state.

20. The apparatus of claim 15, wherein said at least one queue comprises a load instruction queue and a store instruction queue, and wherein the picker is configurable to select a first subset of entries from the load instruction queue and a second subset of entries from the store instruction queue, select a first ready entry from the first subset and a second ready entry from the second subset, and to determine whether to pick or bypass instructions from the first ready entry or the second ready entry based upon said at least one cancel condition.

21. The apparatus of claim 20, comprising at least one execution pipeline configurable to execute instructions from the first ready entry or the second ready entry in response to the instructions from the first ready entry or the second ready entry being picked.

22. A computer readable media including instructions that when executed can configure a manufacturing process used to manufacture a semiconductor device comprising:
at least one queue for holding entries, wherein the queue comprises registers that store information indicating whether an entry is ready for execution; and
a picker configurable to determine that the entry in the queue includes an instruction that is ready to be executed by the processor based on at least one instruction-based event, determine cancel conditions based on global events of the processor concurrently with determining that the instruction is ready, and select the instruction for execution when the cancel conditions are not satisfied.

23. The computer readable media set forth in claim 22, wherein the semiconductor device further comprises at least one finite state machine configurable to set a value of a bit in the register to indicate that the instruction in the entry is ready for execution based on a current state associated with the entry and at least one condition associated with the state.

24. The computer readable media set forth in claim 22, wherein the semiconductor device further comprises at least one execution pipeline configurable to execute the instruction from the ready entry in response to the entry being picked.
